(19) United States
(12) Patent Application Publication
(10) Pub. No.: US 2010/0223295 A1
(43) Pub. Date: Sep. 2, 2010

(54) Applied Semantic Knowledgebases and Applications Thereof

(75) Inventors: Robert A. Stanley, Emeryville, CA (US); Erich A. Gombocz, San Francisco, CA (US)

Correspondence Address: SWANSON & BRATSCHUN, L.L.C., 8210 SOUTHPARK TERRACE, LITTLETON, CO, 80120, US

(73) Assignee: IO INFORMATICS, INC., Berkeley, CA (US)

(21) Appl. No.: 12/758,415

(22) Filed: Apr. 12, 2010

Related U.S. Application Data
(63) Continuation-in-part of application No. 11/217,796, filed on Aug. 31, 2005, now Pat. No. 7,702,639.
Application No. 11/217,796 is a continuation of application No. 10/010,086, filed on Dec. 6, 2001, now Pat. No. 6,988,109.
(60) Provisional application No. 61/223,941, filed on Jul. 8, 2009.
(60) Provisional application No. 60/254,062, filed on Dec. 6, 2000.
(60) Provisional application No. 60/254,063, filed on Dec. 6, 2000.
(60) Provisional application No. 60/254,064, filed on Dec. 6, 2000.
(60) Provisional application No. 60/259,050, filed on Dec. 29, 2000.
(60) Provisional application No. 60/264,238, filed on Jan. 25, 2001.
(60) Provisional application No. 60/266,957, filed on Feb. 6, 2001.
(60) Provisional application No. 60/276,711, filed on Mar. 16, 2001.
(60) Provisional application No. 60/282,654, filed on Apr. 9, 2001.
(60) Provisional application No. 60/282,655, filed on Apr. 9, 2001.
(60) Provisional application No. 60/282,656, filed on Apr. 9, 2001.
(60) Provisional application No. 60/282,657, filed on Apr. 9, 2001.
(60) Provisional application No. 60/282,658, filed on Apr. 9, 2001.
(60) Provisional application No. 60/282,979, filed on Apr. 10, 2001.
(60) Provisional application No. 60/282,989, filed on Apr. 10, 2001.
(60) Provisional application No. 60/282,990, filed on Apr. 10, 2001.
(60) Provisional application No. 60/282,991, filed on Apr. 10, 2001.

(51) Int. Cl. G06F 7/00; G06F 17/30

(52) U.S. Cl. 707/794; 707/803; 707/E17.044; 707/E17.098

(57) ABSTRACT

Novel tools and techniques for generating and/or implementing an applied semantic knowledgebase. Some tools allow for data integration into coherent, semantically connected networks and for generation of sets of query-based models describing complex functional relationships as sub-networks. In an aspect, an applied semantic knowledgebase may comprise collections of SPARQL network queries describing a specific set of sub-network relationships and their applicable ranges for each element in the query.

### CROSS-REFERENCES TO RELATED APPLICATIONS

This application claims the benefit, under 35 U.S.C. §119(e), of provisional U.S. Pat. App. Ser. No. 61/223,941 (Attorney Docket No. 022151-000300US) filed Jul. 8, 2009 and entitled “Applied Semantic Knowledgebases and Applications Thereof”; this application is also is a continuation-in-part of U.S. patent application Ser. No. 11/217,796 (Attorney Docket No. 0418.01/C) filed Aug. 31, 2005 and entitled “System, Method, Software Architecture, and Business Model for an Intelligent Object Based Information Technology Platform” (the “796 Application”), which is a continuation of U.S. Pat. App. Ser. No. 10/010,086, (now U.S. Pat. No. 6,988,109) filed Dec. 6, 2001 and entitled “System, Method, Software Architecture, and Business Model for an Intelligent Object Based Information Technology Platform,” which claims the benefit, under 35 U.S.C. §119(e), of the following provisional patent applications:

Provisional U.S. Pat. App. Ser. No. 60/254,062, filed Dec. 6, 2000 and entitled “Intelligent Molecular Object Data for Heterogeneous Data Environments with High Data Density and Dynamic Application Needs”;

Provisional U.S. Pat. App. Ser. No. 60/254,063, filed Dec. 6, 2000 and entitled “Data Pool Architecture for Intelligent Molecular Object Data in Heterogeneous Data Environments with High Data Density and Dynamic Application Needs”;

Provisional U.S. Pat. App. Ser. No. 60/254,064, filed Dec. 6, 2000 and entitled “Handling Device for Intelligent Molecular Object Data in Heterogeneous Data Environments with High Data Density and Dynamic Application Needs”;

Provisional U.S. Pat. App. Ser. No. 60/259,050, filed Dec. 29, 2000 and entitled “Object State Engine for Intelligent Molecular Object Data Technology”;

Provisional U.S. Pat. App. Ser. No. 60/264,238, filed Jan. 25, 2001 and entitled “Object Translation Engine Interface For Intelligent Molecular Object Data”;

Provisional U.S. Pat. App. Ser. No. 60/276,711, filed Mar. 16, 2001 and entitled Application Translation Interface For Intelligent Molecular Object Data In Heterogeneous Data Environments With Dynamic Application Needs”;

Provisional U.S. Pat. App. Ser. No. 60/266,957, filed Feb. 6, 2001 and entitled “System, Method, Software Architecture and Business Model for an Intelligent Molecular Object Based Information Technology Platform”;

Provisional U.S. Pat. App. Ser. No. 60/282,654, filed Apr. 9, 2001 and entitled “Result Aggregation Engine For Intelligent Object Data In Heterogeneous Data Environments With Dynamic Application Needs”;

Provisional U.S. Pat. App. Ser. No. 60/282,655, filed Apr. 9, 2001 and entitled “System, Method And Business Model For Productivity In Heterogeneous Data Environments”;

Provisional U.S. Pat. App. Ser. No. 60/282,656, filed Apr. 9, 2001 and entitled “Result Generation Interface For Intelligent Molecular Object Data In Heterogeneous Data Environments With Dynamic Application Needs”;

Provisional U.S. Pat. App. Ser. No. 60/282,657, filed Apr. 9, 2001 and entitled “Automated Applications Assembly Within Intelligent Object Data Architecture For Heterogeneous Data Environments With Dynamic Application Needs”;

Provisional U.S. Pat. App. Ser. No. 60/282,658, filed Apr. 9, 2001 and entitled “Knowledge Extraction Engine For Intelligent Object Data In Heterogeneous Data Environments With Dynamic Application Needs”;

Provisional U.S. Pat. App. Ser. No. 60/282,979, filed Apr. 10, 2001 and entitled “Legacy Synchronization Interface For Intelligent Molecular Object Data In Heterogeneous Data Environments With Dynamic Application Needs”;

Provisional U.S. Pat. App. Ser. No. 60/282,989, filed Apr. 10, 2001 and entitled “Object Query Interface For Intelligent Molecular Object Data In Heterogeneous Data Environments With Dynamic Application Needs;” entitled “Object Normalization For Intelligent Molecular Object Data In Heterogeneous Data Environments With Dynamic Application Needs”; and

Provisional U.S. Pat. App. Ser. No. 60/282,991, filed Apr. 10, 2001 and entitled “Distributed Learning Engine For Intelligent Molecular Object Data In Heterogeneous Data Environments With Dynamic Application Needs.”

The present disclosure also may be related to the following commonly assigned applications/patents:

U.S. patent application Ser. No. 10/010,754, filed Dec. 6, 2001 and entitled “Data Pool Architecture, System, And Method For Intelligent Object Data In Heterogeneous Data Environments”;

U.S. patent application Ser. No. 10/010,724, filed Dec. 6, 2001 and entitled “Intelligent Molecular Object Data Structure and Method for Application in Heterogeneous Data Environments with High Data Density and Dynamic Application Needs”;

U.S. patent application Ser. No. 10/010,727, filed Dec. 6, 2001 and entitled “Intelligent Object Handling Device and Method for Intelligent Object Data in Heterogeneous Data Environments with High Data Density and Dynamic Application Needs”;

The respective disclosures of each of the above applications/patents (referred to herein as the “Incorporated Applications”) are incorporated herein by reference in their entirety for all purposes.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD

The present disclosure relates, in general, to data harvesting and knowledge management, and more particularly, to tools and techniques for implementing an applied semantic knowledgebase.

### BACKGROUND

In arenas with heterogeneous multidisciplinary high-density data there is a great need to make sense of all those data in context and to detect and develop models that mimic complex interaction-based processes. Merely by way of non-limiting example, Life Sciences and Healthcare critically necessitate moving beyond data silos towards accessing the accumulative knowledge across disciplines, the enterprise and collaborative institutions. The complexity involved in the understanding biological functions in organisms requires taking advantage of all resources available by combining experimental, analytical and published information into a context-aware environment which accounts for inference and reasoning, and provides a coherent basis for modeling of such processes. There is a tremendous need for reliable, effective and intuitive to use tools for predictive biology in a multitude of scientific and medical arenas to assess risk, outcome and prognosis of interaction, intervention or treatment methods.

Several previously described approaches either commonly lack underlying common principles or mechanisms to define a reasonably reliable methodology or require extreme measures to provide for such functionality in a limited way. Semantic data models and their intrinsically embedded relationship characterization—while necessitating a foundation for efforts to meaningfully extract characteristics describing data in form of interconnected network graphs—are helpful in integrative data coherence, but the wide use of graph-based system approaches has been hampered by overload of relationships inherent in biological systems and the complexity in functional interpretation. SPARQL, a resource description framework (“RDF”) query language (its recursive acronym stands for “SPARQL Protocol and RDF Query Language”) has been described as representing a key search functionality of the semantic web.

### BRIEF SUMMARY

A set of embodiments generates and/or implements an applied semantic knowledgebase (“ASK”). In an embodiment, an ASK provides a software framework that allows users to harvest data, experience and/or knowledge. Beneficially, this framework can enable users to apply resulting insights and achieve research goals in complex systems. In one aspect, it can represent a collection of practically applicable network models for screening and/or predictive use in otherwise inaccessible information content buried in large and complexly intertwined datasets.

In another aspect, certain embodiments provide tools and techniques for creating and/or implementing ASKs. In some cases, such embodiments employ software that provides tools for data integration into coherent, semantically connected networks and for generation of sets of query-based models describing complex functional relationships as sub-networks. In an aspect, an ASK may comprise collections (or “arrays”) of SPARQL network queries describing a specific set of sub-network relationships and their applicable ranges for each element in the query comprising a trainable, refinable, applicable model for a biological subsystem. Such subsystems can include, merely by way of example, the progression of a specific disease type, the toxic response towards treatment and the like. In an novel aspect, certain embodiments can provide a methodology for practical, reliable and widely applicable model generation and/or automatic screening of large datasets for specific, identified functions.

Other embodiments enable the generation, refinement, storage and/or application of SPARQL queries for predictive modeling and/or screening to provide informed decision-support for high value questions. Such questions can include, again without limitation, biomarkers for early identification of drug efficacy; presymptomatic toxicity detection; recognition of presymptomatic organ failure; identification and stratification of cases by disease type for targeted trials or treatment; and other high value knowledge applications requiring queries with “embedded systems expertise.” An ASK implemented in accordance with certain embodiments can deliver the ability to combine experimental, analytical and/or published information within coherent semantic networks to rapidly create, visualize, test and/or apply real, practically relevant knowledge. This practical knowledge makes it possible to detect previously hidden conditions and relationships that are necessary to make informed decisions in complex, high value areas of interest.

The tools provided by various embodiments include, without limitation, methods, systems, and/or software programs. Merely by way of example, a method might comprise one or more procedures, any or all of which are executed by a computer system. Correspondingly, an embodiment might provide a computer system configured with instructions to perform one or more procedures in accordance with methods provided by various other embodiments. Similarly, a computer program might comprise one or more processors, along with a computer readable medium in communication with the processors that has encoded thereon a set of instructions that are executable by a computer system (and/or a processor therein) to perform such operations. In many cases, software programs in accordance with various embodiments comprise instructions that are executable by a computer system to perform one or more operations. Certain embodiments provide an apparatus comprising a physical and/or tangible computer readable media (such as, to name but a few examples, optical media, magnetic media, and/or the like) that is encoded with such instructions.

Merely by way of example, a method in accordance with one set of embodiments comprises importing, into an informatics program, a plurality of sets of data from a plurality of sources. The method, in an aspect, might further comprise synthesizing the plurality of sets of data to produce a coherent data set, and/or creating one or more semantic networks, the semantic networks expressing data relationships among data in the coherent data set. In some embodiments, the method further comprises obtaining a pattern characteristic for a biologically relevant function by reducing network complexity of the one or more semantic networks. The method might also comprise generating one or more SPARQL arrays from the pattern characteristic, storing the one or more SPARQL arrays in a database, and/or generating an applied semantic knowledgebase from the one or more SPARQL arrays.

A method in accordance with another set of embodiments comprises generating an applied semantic knowledgebase from one or more SPARQL arrays and screening an unknown data population with one or more of the SPARQL arrays. The method might further comprise identifying one or more relationships in the unknown data population, based on the screening, and/or displaying an indication of the one or more relationships in a user interface.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. In some instances, a sub-label is associated with a reference numeral to denote one of multiple similar components. When reference is made to a reference numeral without specification to an existing sub-label, it is intended to refer to all such multiple similar components.

FIG. 1A is a process flow diagram illustrating a method of generating an ASK and/or applying the ASK for decision support, in accordance with various embodiments.

FIG. 1B is a process flow diagram illustrating a detailed method of generating and/or applying an ASK.

FIG. 2 is a schematic representation of semantically linked data, in accordance with various embodiments.

FIG. 3A is an exemplary screen display illustrating a user interface displaying a SPARQL graph query, in accordance with various embodiments.

FIG. 3B is an exemplary screen display illustrating a user interface displaying an auto-generated textual representation of the SPARQL query of FIG. 3A, in accordance with various embodiments.

FIG. 4A illustrates a subnetwork of combinatorial biomarkers, in accordance with various embodiments.

FIG. 4B is an exemplary screen display illustrating a user interface displaying an auto-generated textual representation of the subnetwork of FIG. 4A, in accordance with various embodiments.

FIG. 5A is an exemplary screen display showing a user interface displaying a query interface, in accordance with various embodiments.

FIG. 5B illustrates a single SPARQL array subnetwork generated from a query, in accordance with various embodiments.

FIG. 6 is an exemplary screen display illustrating a SPARQL query for dose dependency of treatment toxicity, in accordance with various embodiments.

FIG. 7 is an exemplary screen display illustrating a “hit-to-fit” assessment of a plurality of SPARQL queries, in accordance with various embodiments.

FIG. 8A is a process flow diagram illustrating a method of creating an applied semantic knowledgebase, in accordance with various embodiments.

FIG. 8B is a process flow diagram illustrating a method comprising various tasks for which an applied semantic knowledgebase can be used, in accordance with various embodiments.

FIG. 9 is a generalized schematic diagram illustrating a computer system, in accordance with various embodiments.

FIG. 10 is a block diagram illustrating a networked system of computers, which can be used in accordance with various embodiments.

### DETAILED DESCRIPTION OF CERTAIN EMBODIMENTS

While various aspects and features of certain embodiments have been summarized above, the following detailed description illustrates a few exemplary embodiments in further detail to enable one of skill in the art to practice such embodiments. In the following description, for the purposes of explanation, numerous specific details are set forth in order to provide a thorough understanding of the described embodiments. It will be apparent to one skilled in the art, however, that other embodiments of the present may be practiced without some of these specific details. In other instances, certain structures and devices are shown in block diagram form. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features.

In another aspect, certain embodiments provide tools and techniques for creating and/or implementing ASKs. In some cases, such embodiments employ software that provides tools for data integration into coherent, semantically connected networks and for generation of sets of query-based models describing complex functional relationships as sub-networks. In an aspect, an ASK may comprise collections (or “arrays”) of SPARQL network queries describing a specific set of sub-network relationships and their applicable ranges for each element in the query comprising a trainable, refinable applicable model for a biological subsystem. Such subsystems can include, merely by way of example, the progression of a specific disease type, the toxic response towards treatment and the like. In an novel aspect, certain embodiments can provide a methodology for practical, reliable and widely applicable model generation and/or automatic screening of large datasets for specific, identified functions.

Other embodiments enable the generation, refinement, storage and/or application of SPARQL queries for predictive modeling and/or screening to provide informed decision-support for high value questions. Such questions can include, again without limitation, biomarkers for early identification of drug efficacy; presymptomatic toxicity detection; recognition of presymptomatic organ failure; identification and stratification of cases by disease type for targeted trials or treatment; and other high value knowledge applications requiring queries with “embedded systems expertise.” An ASK implemented in accordance with certain embodiments can deliver the ability to combine experimental, analytical and/or published information within coherent semantic networks to rapidly create, visualize, test and/or apply real, practically relevant knowledge. This practical knowledge makes it possible to detect previously hidden conditions and relationships that are necessary to make informed decisions in complex, high value areas of interest.

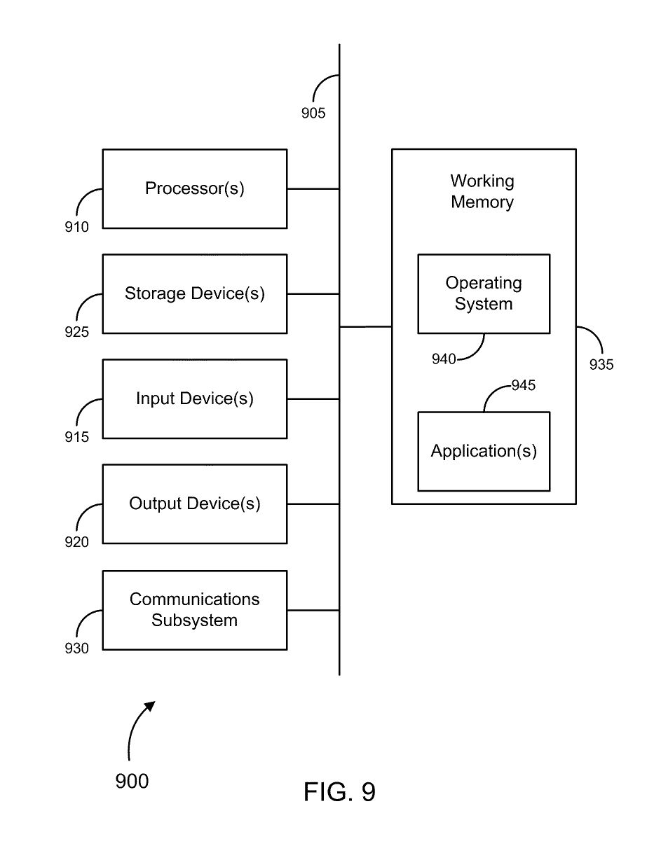

One set of embodiments provides a computer system for generating and/or implementing an ASK. An exemplary architecture of one such computer system is described below with respect to FIG. 9. In an aspect, such a computer system provides a user interface to allow users to interact with the computer system. A variety of user interfaces may be provided in accordance with various embodiments, including without limitation graphical user interfaces that display, for a user, display screens for providing information to the user and/or receiving user input from a user. Several examples of such display screens are described below.

Merely by way of example, in some embodiments, a standalone application on a client computer might be used to generate and/or implement an ASK; in such cases, this application might generate a user interface for display on a display device connected with the client computer. In other embodiments, a computer system may be configured to communicate with a client computer via a dedicated application running on the client computer; in this situation, the user interface might be displayed by the client computer, based on data and/or instructions provided by the computer system. Hence, providing the user interface might comprise providing the instructions and/or data to cause the client computer to display the user interface. In further embodiments, the user interface may be provided from a web site that is incorporated within (and/or in communication with) the computer system, e.g., by providing a set of one or more web pages, which may be displayed in a web browser running on a user's computer and/or served by a web server. In various embodiments, the computer system might comprise the web server and/or be in communication with the web server, such that the computer system provides data to the web server to be served as web pages for display by a browser at the user computer.

Other embodiments provide methods and techniques of generating and/or implementing an ASK. While several such methods and techniques are described separately below for ease of description, it should be appreciated that the various techniques and procedures of these methods can be combined in any suitable fashion, and that, in some embodiments, these techniques and procedures can be considered interoperable and/or as portions of a single method. Similarly, while the techniques and procedures are depicted and/or described in a certain order for purposes of illustration, it should be appreciated that certain procedures may be reordered and/or omitted within the scope of various embodiments. In some cases, these methods may be implemented on a computer system, which is programmed with and/or executes instructions embodied on a computer readable medium to perform various operations in accordance with these methods.

Methods in accordance with certain embodiments comprise providing a user interface to allow interaction between a user and a computer system. For example, the user interface can be used to output information for a user, e.g., by displaying the information on a display device, printing information with a printer, playing audio through a speaker, etc.; the user interface can also function to receive input from a user, e.g., using standard input devices such as mice and other pointing devices, keyboards (both numeric and alphanumeric), microphones, etc. The procedures undertaken to provide a user interface, therefore, can vary depending on the nature of the implementation; in some cases, providing a user interface can comprise displaying the user interface on a display device; in other cases, however, where the user interface is displayed on a device remote from the computer system (such as on a client computer, wireless device, etc.), providing the user interface might comprise formatting data for transmission to such a device and/or transmitting, receiving and/or interpreting data that is used to create the user interface on the remote device. Alternatively and/or additionally, the user interface on a client computer (or any other appropriate user device) might be a web interface, in which the user interface is provided through one or more web pages that are served from a computer system (and/or a web server in communication with the computer system), and are received and displayed by a web browser on the client computer (or other capable user device). The web pages can display output from the computer system and receive input from the user (e.g., by using Web-based forms, via hyperlinks, electronic buttons, etc.). A variety of techniques can be used to create these Web pages and/or display/receive information, such as JavaScript, Java applications or applets, dynamic HTML and/or AJAX technologies.

In many cases, providing a user interface will comprise providing one or more display screens (a few examples of which are described below), each of which includes one or more user interface elements. As used herein, the term “user interface element” (also described as a “user interface mechanism” or a “user interface device”) means any text, image or device that can be displayed on a display screen for providing information to a user and/or for receiving user input. Some such elements are commonly referred to as “widgets,” and can include, without limitation, text, text boxes, text fields, tables and/or grids, charts, hyperlinks, buttons, lists, combo boxes, checkboxes, radio buttons, and/or the like. While the exemplary display screens described herein employ specific user interface elements appropriate for the type of information to be conveyed/received by computer system in accordance with the described embodiments, it should be appreciated that the choice of user interface element for a particular purpose is typically implementation-dependent and/or discretionary. Hence, the illustrated user interface elements employed by the display screens described herein should be considered exemplary in nature, and the reader should appreciate that other user interface elements could be substituted within the scope of various embodiments.

As noted above, in an aspect of certain embodiments, the user interface provides interaction between a user and a computer system. Hence, when this document describes procedures for displaying (or otherwise providing) information to a user, or to receiving input from a user, the user interface may be the vehicle for the exchange of such input/output.

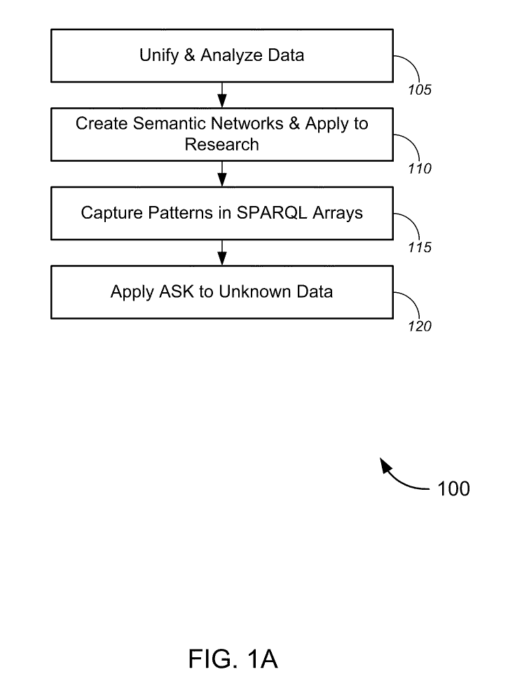

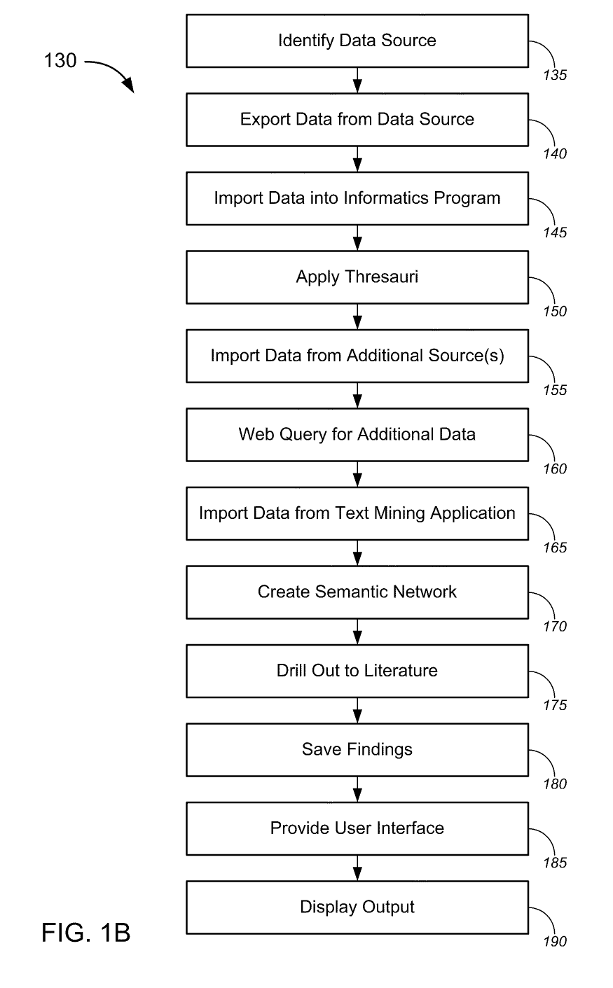

FIG. 1A illustrates a method depicting several procedural steps involved in the creation and/or application of an ASK in accordance with one set of embodiments. First, data from multiple sources and modalities are synthesized to provide a coherent data set (block 105). This synthesis may comprise combining, integrating, unifying, normalizing, and/or analyzing the data. Next, semantic networks are created to express data relationships in context and to rapidly create, visualize, test and apply real, practically relevant knowledge (block 110). In an aspect of certain embodiments, this procedure involves representing data classes in a common ontology for interaction and integration with public domain resources to merge and incorporate those curated findings with experimental and internal knowledge.

Next, this knowledge is applied to research to obtain pattern characteristic for a biologically relevant function by reducing network complexity to a minimum set of components required to describe it. The resulting graph pattern is then captured in the form of SPARQL arrays (block 115). Said arrays are saved (e.g., in a database or other appropriate data structure on a storage medium), and their collection of various biological functions and/or organisms responses comprises the ASK. Lastly, the ASK arrays or profiles are applied to screening of unknown data populations as predictive models for decision support (block 120). This process makes it possible to detect previously hidden conditions and relationships that are necessary to make the informed decisions required in complex, high value areas of interest.

FIG. 1B illustrates a method 130 comprising a detailed workflow that provides an example of one implementation of this general process. (It should be appreciated, of course, that other embodiments may employ different workflow profiles). The method 130 includes, at block 135, identifying at least one experimental data source of interest (e.g. gene expression, compounds, clinical endpoints). This data source might be identified, by example, based on user input specifying a location of the data source. In an aspect, this data source might be a database of experimental data. In some embodiments, the method 130 further comprises exporting a data subset of interest (e.g. a gene list, toxicity markers) from an experimental database in XML or other delimited format (block 140).

In an aspect, the method 130 may also include, at block 145, importing the data subset into informatics program under any combination of ontologies and thesauri (many of which, such as gene ontology (“GO”), Web Ontology Language (“OWL”), etc. are known in the art), which can be imported from the system's own data manager, merged with local and public ontologies, and/or created ab initio in an informatics program. One example of such an informatics program is Sentient Knowledge Explorer™ available from IO Informatics, Inc. Sentient Knowledge Explorer is an example of an informatics program that gives end-users the power to meaningfully interpret their data; it an easy to use tool that simplifies the creation of reduced dimension models that display and connect elements that are relevant to goal-driven visualization and filtering of complex data and data relationships. With such a tool, researchers can create associative networks with functional relationships from their own data and can drill directly out to experimental and analyzed information, and can merge this information with public domain knowledge from valuable public sources such as Entrez™, KEGG™, and PubMed™, to name a few examples.

In some cases, the method 130 may include, as needed, applying internally created or use published thesauri (block 150), and/or importing delimited experimental data from additional sources, such as gene lists, toxicity data, and/or the like (block 155). In some cases, the system may employ a web query to query published pathway and interactions data, e.g., from sources such as IntAct™, BioGrid™, and/or the like (block 160). If necessary, the method 130 can include importing data from text mining applications (block 165), which can obtain textual data from a variety of data sources, including without limitation those described above.

At block 170, the method 130 comprises filtering and/or and merging results to create a unified semantic network, e.g., within an informatics program, such as Semantic Knowledge Explorer. In some embodiments, the method 130 can further comprise drilling out from the informatics program to published, ranked literature sources (Entrez™/PubMed™, UniProt™, HMDB™, to name a few examples) to annotate findings with full supporting literature references as needed (block 175). Findings may be saved (block 180), e.g., as a list export or as a semantic network, and/or refined as needed.

The system thus can provide a user interface (block 185), as described above, to allow a user to browse and explore experimental data relationships, query content, and/or the like. This functionality can allow the user to discover intersections and/or unexpected relationships. The system can be used to achieve a specific outcome (for example, the system can allow the user to “Visualize all identified biomarkers within a unified network, for tissue-specific toxicity in a set of compounds; review correlations and underlying mechanisms, annotate with references”). In a specific embodiment, the system can use SPARQL Arrays (such as disease, toxicity, and/or responder signatures) as filters to be applied to unknown datasets. At block 190, the method comprises displaying output. Examples of output displays are described in further detail below, but in general such output can include the results of queries, filter operations, representations of relationships in analyzed data, and/or the like. The output can be displayed on a computer monitor, displayed as a printout, etc. In some cases, displaying output might comprise providing the output from a server computer to a client computer for display by the client computer.

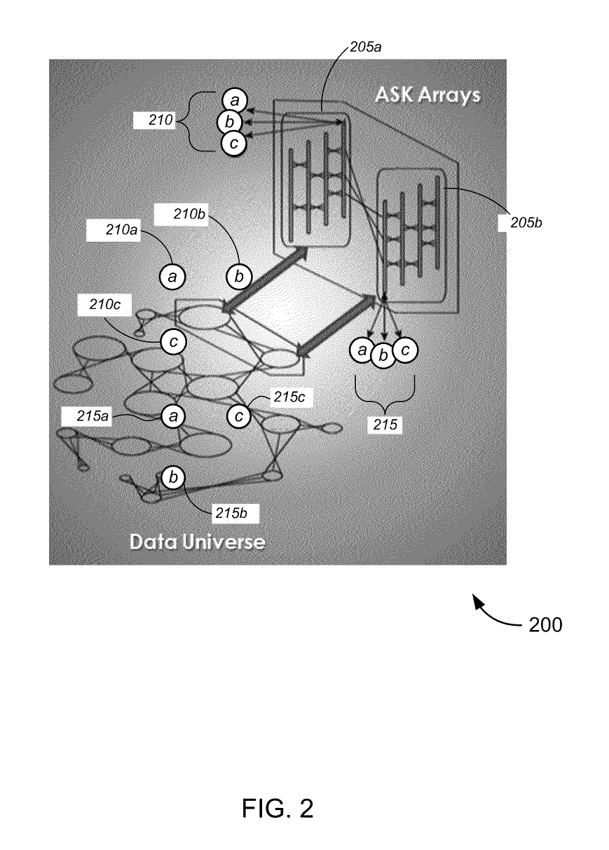

FIG. 2 illustrates a schematic representation 200 of semantically linked data, represented as sets of SPARQL queries (arrays) contained in an ASK. These arrays illustrate the results on efficacy and toxicity of three treatment compounds. This representation depicts the data universe as a set of linked data in accordance with one set of embodiments. In the illustrated representation, each circle representing a separate data modality or database. The ASK arrays 205 in the rounded rectangles in the upper part of the graphic represent sets of SPARQL queries representing a specific biological function or condition (such as, for example, a state of a disease, a classification of a specific tumor type or an immunological or toxicological response to a particular treatment in a particular group of patients). The results from the executed queries using ASK (circles 210 for compound efficacy and circles 215 for toxicity) are shown in both the ASK arrays and their corresponding location in the data universe.

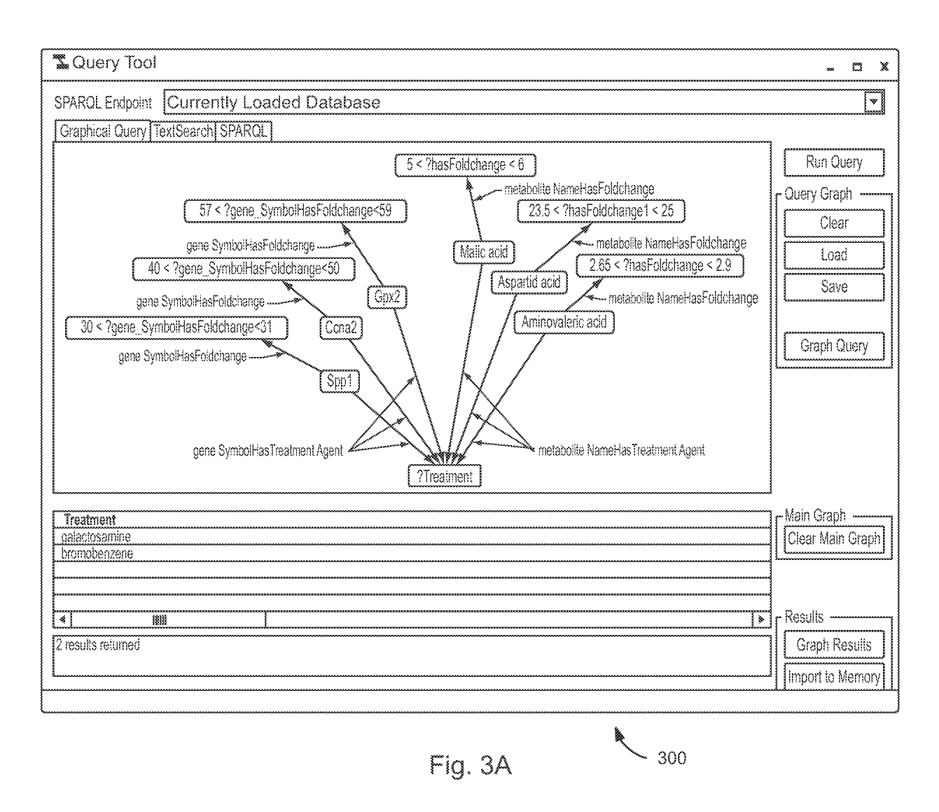

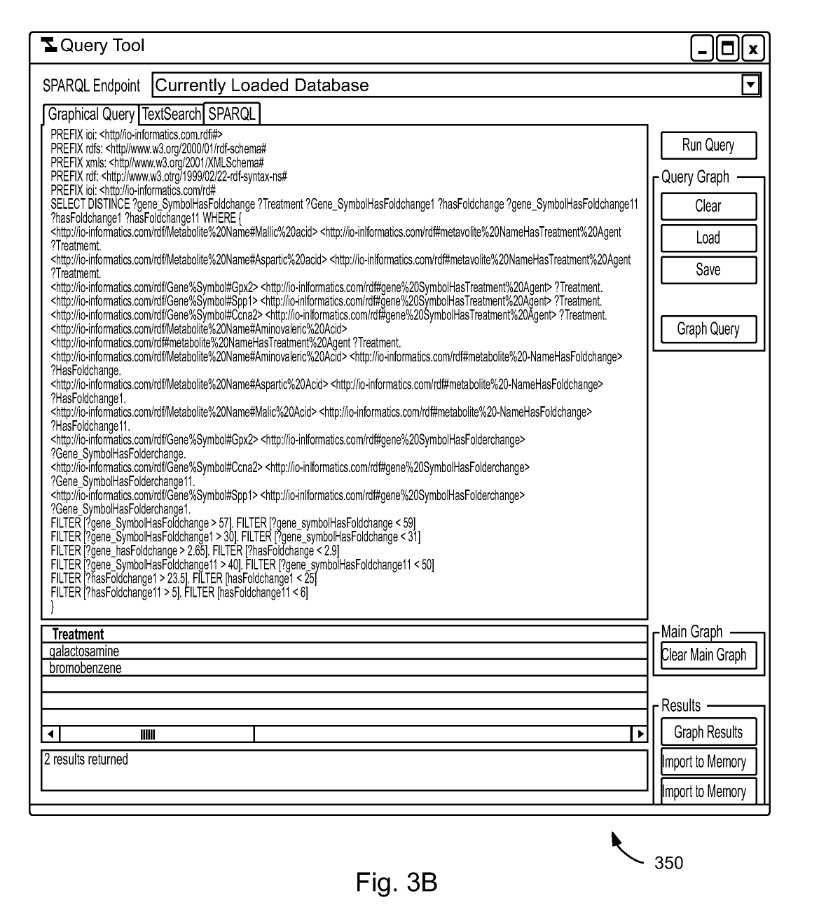

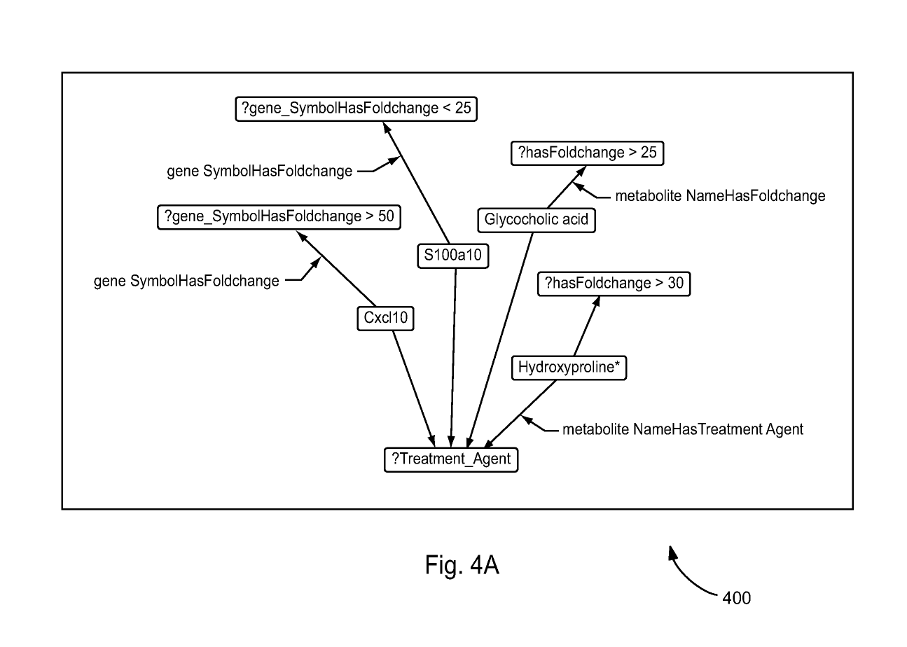

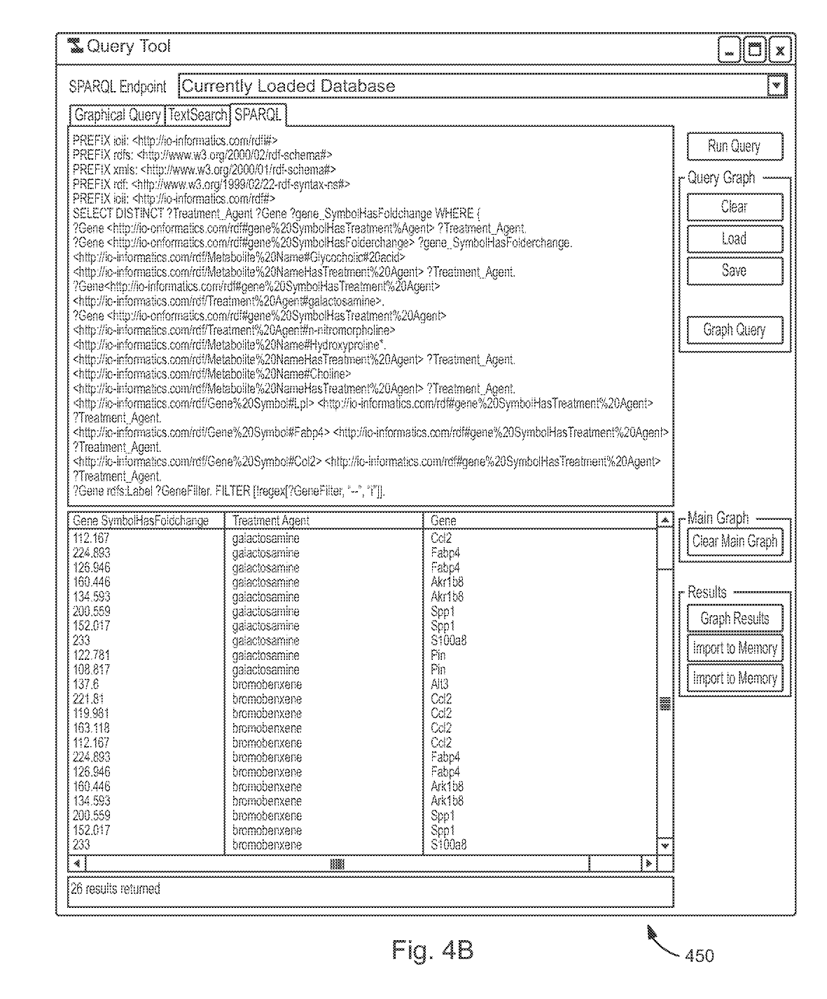

The process of generating and fielding such a query is depicted in the exemplary screen displays 300, 350, 400 and 450 of FIGS. 3A, 3B, 4A and 4B, respectively, in an example scenario for predictive biology of toxicity. (It should be appreciated, of course, that the techniques described herein find wide applicability, and the example scenario described below is provided for illustrative purposes only.) To generate a SPARQL query profile the first time, the user selects all relevant nodes from the graphical network representing the biological system. This selection can account for similarities or differences between certain parameters relevant to the objective of research, as well as inclusion or exclusion of certain data relationships based on relevancy to the specific problem. For example, commonalities of toxic responses across different tissues can be used to design biomarker profiles relevant for a tissue of interest (for example, liver toxicity), which also are prevalent for assaying in a much easier accessible tissue (for example, urine or blood tests).

The user then simply selects the nodes in the resulting sub-network and opens the query tool, which will transfer the graph into it (as shown in FIGS. 3A, 4A). At that point, specific conditions can be defined (such as ranges, as in the exemplary display 300 of FIG. 3A or foldchange conditions, as in the exemplary display 400 of FIG. 4A, to name a few examples) to establish a model for the biological function of interest. Once these conditions are set, the entire graph query with its rules (SPARQL Array) can be saved and tested on known examples to validate its applicability and/or to refine the confidence settings. Once this step has been completed, said profiles can be automatically applied to unknown datasets for screening, and iteratively used whenever new data are added. The example display 300 in FIG. 3A shows a combinatorial biomarker profile obtained from a large set of metabolic (>1600 metabolites) and genetic (>30000 probes) responses on animal models in several tissues and across different time points at different doses. The power of this technology is exemplified by the fact, that from the entire biological network, only the small set of 3 genomic and 3 metabolic markers at specific expression rates are needed to describe toxicity effects for a class of treatments. The query can be generated automatically without any user interaction (as illustrated by FIGS. 3B, 4B) based on the selected nodes in the subnetwork or from a saved collection. Queries may be set, for example, to run at designated time intervals or whenever new data enters the system or a defined state has been reached. The results of the query can be displayed (e.g., as a graph) or exported for further use. In the example display 400 illustrated by FIG. 4A, other affected genes with their expression changes are also identified together with treatments classified as toxic.

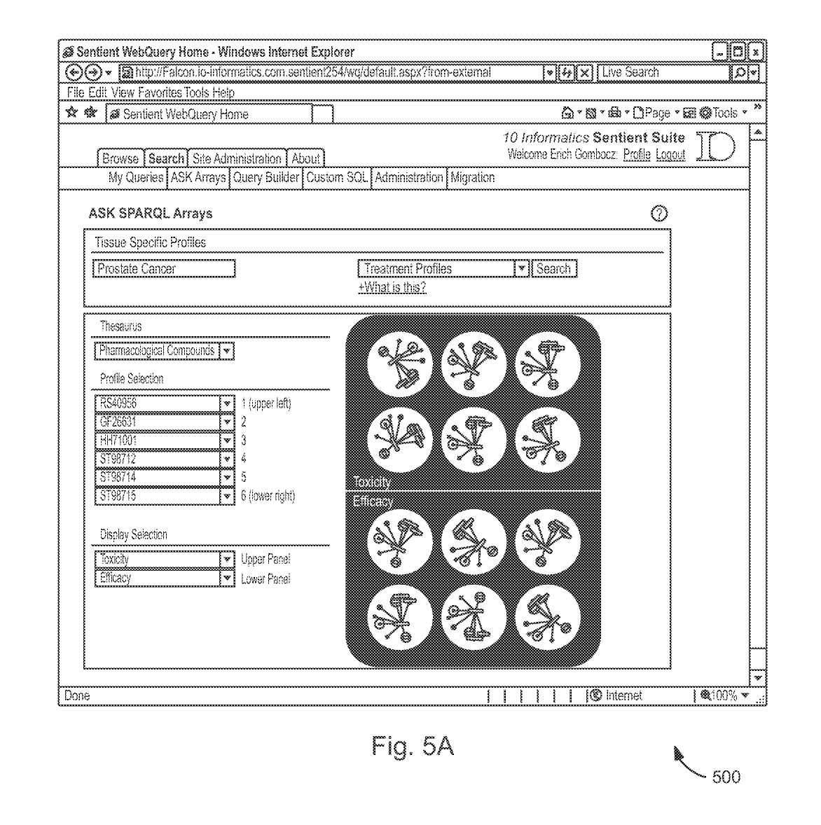

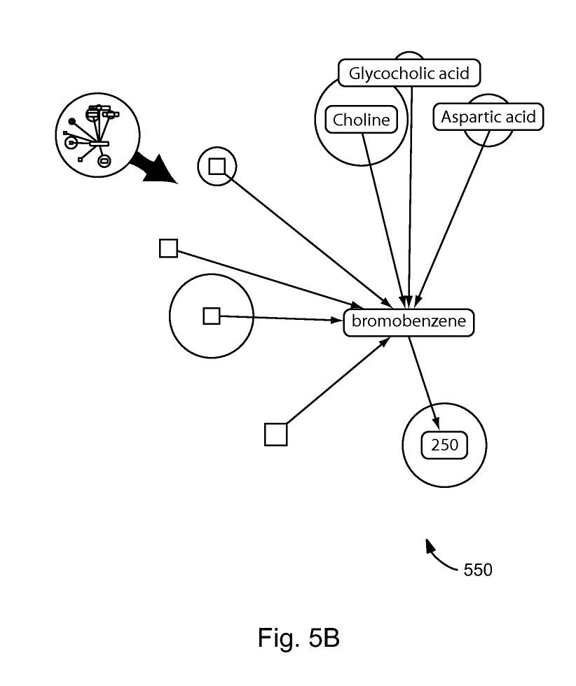

While the Query Tool depicted in the exemplary displays 300, 350, 400, and 450 of FIGS. 3 and 4 can be used to provide the initial models, and save arrays of such SPARQL queries in the ASK, certain embodiments allow users who want to apply ASK to interact with the system via a web-based interface from anywhere with a browser and a network connection. (In other embodiments, the Query Tool of FIGS. 3 and 4 may be provided via a web-based interface as well). Merely by way of example, FIG. 5A illustrates an exemplary web-based user interface 500 that allows a user to generate a query across different ASKs. In the example screen of FIG. 5A, a set of compounds is tested for treatment of prostate cancer. The ASK SPARQL Arrays are used to predict toxicity and efficacy of each of the suggested treatments (in this example, 6 different pharmacological compounds) for a specific prostate cancer tumor. Note that the individual profiles screened against are displayed in form of circular icon-style representations; the upper panel shows toxicity, the lower panel shows efficacy. In both panels, one specific profile is highlighted in red as the best match. FIG. 5B depicts an enlarged detail view 550 of such this array, using a “network icon” representation of a single SPARQL array sub-network (including confidence ranges), which are indicated by the size of the circles.

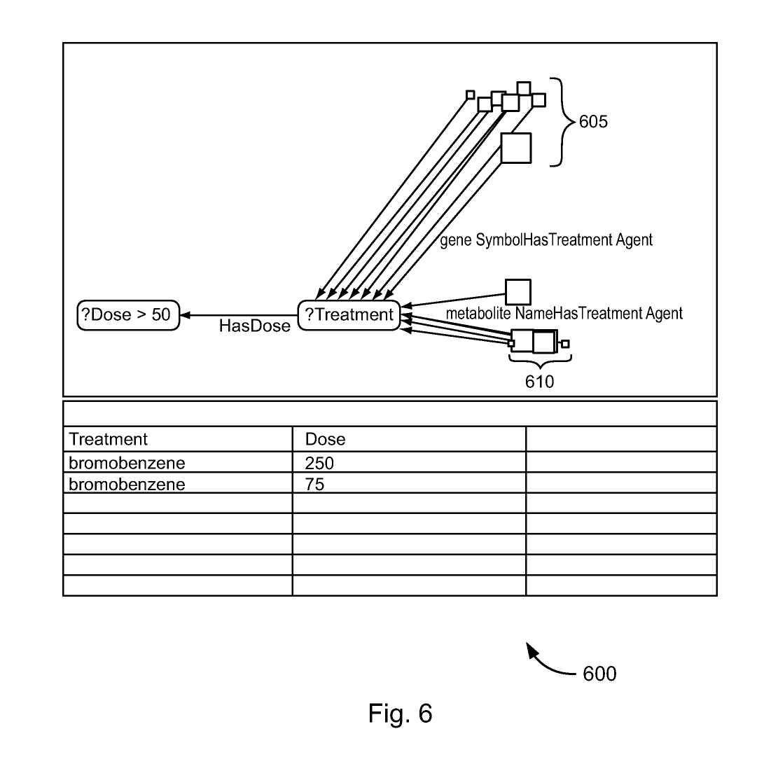

FIG. 6 illustrates an exemplary display 600 showing SPARQL query for dose dependency of treatment toxicity, including a sub-network comprising eleven biomarkers, which include five metabolites 605 and six genes 610, along with their responses for defined treatment doses. This example illustrates how an ASK array is used to query for doses where treatments become toxic to an organism, and it provides results to predict any treatment with a dose over 50 which causes toxicity as described by the profile. As illustrated by the table, the query produces two treatments and their corresponding doses when applied to a compendium of different treatments. Such decision support is of great value in therapy and treatment to optimize the therapeutic effect of a drug at the same time as minimizing its toxic side effects.

While the above descriptions are instructive for a specific case, it should be obvious to anybody skilled in the art that the foregoing is only added for instructional purposes, but does not limit the application of the methodology of ASK to such uses.

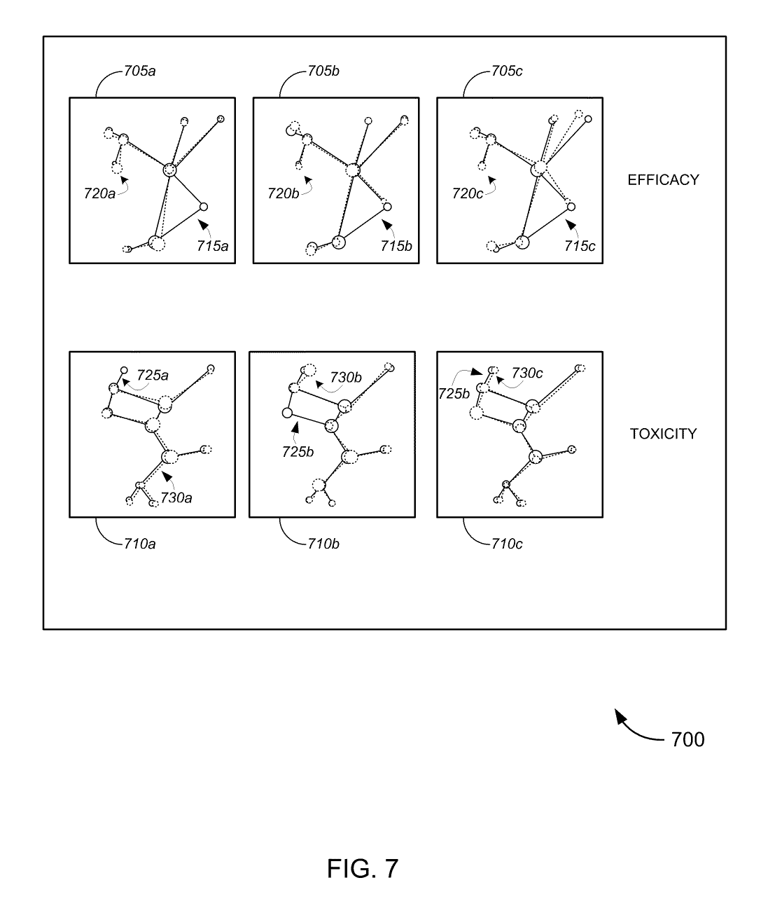

In displaying output, to account for the quality of prediction and its validity in a specific application, specific SPARQL arrays can be overlaid with the actual response profiles, as illustrated by exemplary output screen display 700 of FIG. 7 (referred to as a “hit-to-fit” mapping). In the demonstrated example, a set of different pharmacological compounds used for a disease treatment is screened for a particular type of toxicity and efficacy. For each compound, there is a panel 705 pertaining to toxicity and a panel 710 pertaining to efficacy. The networks 715, 725 shown in solid lines (which, in an actual display, may be represented by a first color) represent the ASK reference sub-network, as defined by a SPARQL query, and the overlaid networks 720, 730 (which are shown in broken lines in FIG. 7 but might be represented by a second color in an actual display) represent the individual compound responses. The size of the circle on each network node indicates the confidence envelope of that node, which can be expressed by the tolerance range from multiple measurements. Larger circles indicate larger (more inaccurate) tolerances for a particular node in the network graph.

Thus, for a particular compound, there will be a panel 705a illustrating the correlation between the compound's actual efficacy response profile 720a and an ASK reference subnetwork 715a, and a panel 710a illustrating the correlation between the compound's toxicity response profile 725a and a corresponding ASK reference sub-network 730a. (While FIG. 7 illustrates panels for three compounds, it should be appreciated that different embodiments can display any reasonable number of compounds.) The overlay expresses graphically the “goodness of fit” between the model and the actual biological response for each of the compounds. The closer the overlay is, the better is the quality of the prediction. This can be used, for example, to stratify experimental compounds for early detection of efficacy or toxicity based on closeness of fit to a reference array generated from a SPARQL algorithm.

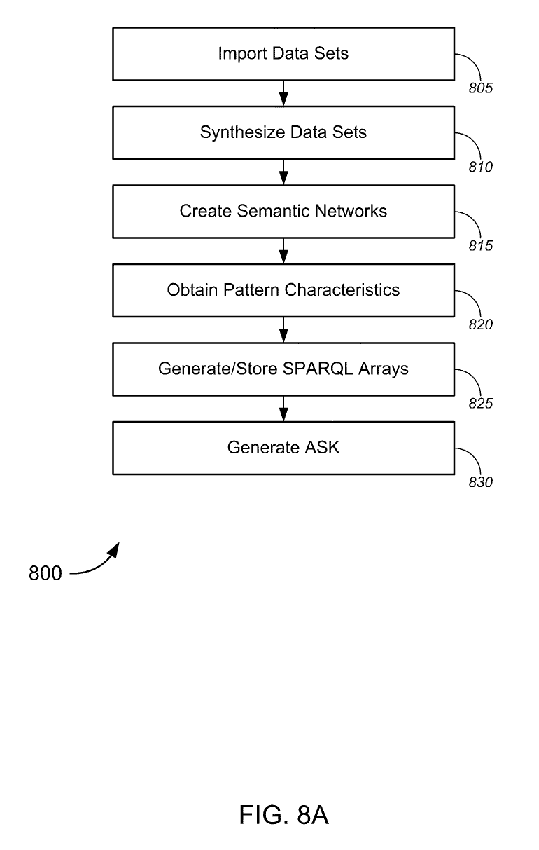

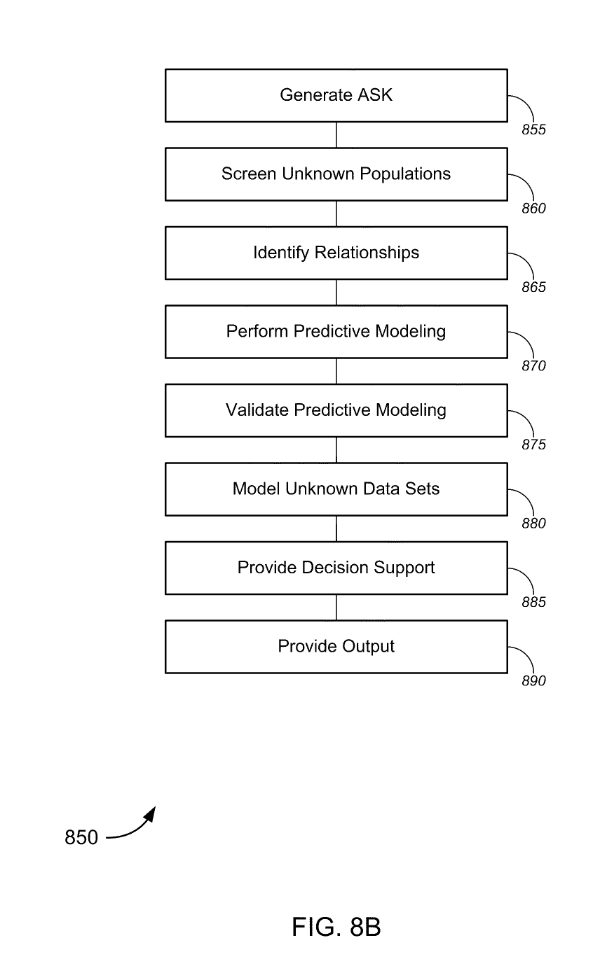

FIG. 8A illustrates a method 800 of creating an ASK, and FIG. 8B illustrates a method 850 of implementing an ASK. The methods 800 and 850 comprise several procedures that are similar, in many respects, to procedures described above with respect to FIGS. 1A and 1B. Moreover, as noted above, the procedures described with respect to each method should be considered interchangeable.

The method 800 comprises importing a plurality of sets of data from one or more data sources (block 805). Several such data sources are described above, and others can include, without limitation, experimental data from genomics, proteomics, metabolomics, tissue analysis, molecular and medical imaging, chemical assays and the like. Other types of data sources are possible as well.

At block 810, the data sets are synthesized to produce a coherent data set. In one aspect, synthesis of a plurality of data sets comprises normalization of the data in each data set, to ensure that the data in each data set can be analyzed consistently. Synthesis of data sets can include any other operation that can facilitate the process of creating a unified data set out of two or more disparate data sets. Additionally and/or alternatively, one or multiple thesauri may be applied to harmonize synonyms or nomenclature differences in those datasets during synthesis. In another aspect, two or more data sets may be synthesized by merging the data sets under a common ontology, as described in more detail in the Incorporated Applications.

In certain embodiments, the method 800 further comprises creating one or more semantic networks from the coherent data set (block 815). In an aspect, the merging of the data sets under a common ontology can be also be considered one component in the creation of a semantic network. Incorporated Applications also describe other procedures that can be used to create and employ a semantic network. In general, however, a semantic network provides the ability to detect, among large, diverse data sets, patterns and relationships that would otherwise be difficult or impossible to discern. Thus, in an aspect, the semantic networks created by various embodiments can express data relationships among data within the coherent data set from which they were created.

At block 820, the method 800 comprises obtaining a pattern characteristic. In an aspect, a pattern characteristic describes a pattern and/or relationship among data in the semantic network(s), particularly in regard to a feature or descriptor of interest. Merely by way of example, in the bioinformatics field, a feature of interest often will be a biologically relevant function (e.g., of a compound or drug). Examples could include, as described above, efficacy of a compound in treating or addressing a particular condition, toxicity of a compound, and/or the like. In particular embodiments, this pattern characteristic can be identified or otherwise obtained by reducing network complexity within the semantic network(s). In some cases, user input may be used to define sub-networks. In such a case, a plurality of markers (each of which corresponds to a set of data within the cohesive data set from which the semantic network is constructed can be displayed for the user. The user might then select a set (e.g., two or more) of these markers, based, in some cases, on a pattern characteristic corresponding to the feature or descriptor of interest (which may be expressed by the display characteristics of the markers, other characteristics of the data represented by the markers, etc.). In other cases, network complexity can be reduced by an automated procedure that does not require user input. As a non-limiting example, in finding connection paths within the data, the system can be set to a specified level of depth, so as to display only those network nodes that are related at the specified level of depth (i.e., to a particular degree). In another example, the display of literals defining certain properties and their connections can be automatically suppressed to avoid connection overload in the displayed graph. In any case, the selected set of markers thus can represent a sub-network of the semantic network, and the pattern characteristic, therefore, can be expressed as a set of one or more sub-networks within the semantic network, each of the sub-networks pertaining to the feature or descriptor of interest.

At block 825, the method 800 comprises generating and/or storing one or more SPARQL arrays from the pattern characteristic. As noted above, a SPARQL array can be considered, in one aspect, to be a collection of SPARQL network queries. In an aspect of certain embodiments, each of those SPARQL queries in the collection can be directly generated by means of a visual query. To generate a visual SPARQL query, the user might simply select one or more nodes of interest in the network graph individually or by drawing a box around a group of nodes. In some cases, individual nodes can be made variable or set to ranges for specific parameterization. In an embodiment, these selections will automatically generate the needed SPARQL code without any other user interaction required. Accordingly, the SPARQL array can be created from queries that produce the pattern characteristics in the semantic network, allowing those queries (and the patterns/relationships they express) to be stored for later recall and/or use. In one aspect, storing the SPARQL array(s) might comprise storing the arrays in a database or other appropriate data store.

The method 800 further comprises, in some embodiments, generating an ASK from the stored SPARQL arrays (block 830). In an aspect, the knowledge representation in each of those stored SPARQL arrays represents an actionable, parameterized semantic subnetwork, which is directly applicable to interrogate new or extended data networks for matching components and their fit in accordance with the SPARQL arrays represented in the ASK. The SPARQL arrays are generated as described above via visual queries according to the required process characteristics in question (e.g., a specific biological function, disease state, toxicity condition, treatment response). Hence, the specific knowledge represented by these SPARQL arrays can be used to form a knowledgebase, or more particularly, an applied semantic knowledgebase. In other cases, patterns and/or profiles representing characteristics within a dataset can be used to generate an ASK. For example, datasets applicable to predictive modeling or screening can be analyzed, as described above and in the Incorporated Applications to identify such patterns and/or profiles, and/or SPARQL queries can be performed to identify such patterns and/or profiles; these queries, then, can be used to generate an ASK from the identified patterns and/or profiles. Such queries might be textual, graphical, and/or numeric.

As described above, an ASK can be employed for many different purposes. FIG. 8B illustrates a method 850 that comprises several procedures that can be used, either individually or in conjunction, as applications of an ASK. For example, the method 850 comprises generating an ASK (block 855). There are several techniques that can be used to generate an ASK, and a few examples of such techniques are described in detail above, particularly with respect to FIGS. 1A, 1B, and 8A. In accordance with some embodiments, the techniques used to generate the ASK are discretionary.

One use of an ASK, as noted above, is to identify patterns and relationships in an unknown data population. So, for example, an ASK, which itself may be generated from one or more pattern characteristics, can be used to identify patterns and/or relationships within other data populations. In fact, the identified patterns and/or relationships in the unknown data population can be used to refine the SPARQL queries from which the ASK is constructed, and by extension, to refine the ASK itself.

Accordingly, the method 850 comprises screening one or more unknown data populations with one or more of the SPARQL arrays within the ASK (block 860). Screening an unknown data population can comprise using the SPARQL queries to filter the unknown data population, so as to identify data satisfying one or more of the SPARQL queries. In this way, the method 800 can also comprise identifying one or more relationships among the data in the unknown data population, based on the screening (block 865).

In another embodiment, the method 800 can include performing modeling tasks with the ASK (870). Merely by way of example, an ASK can be used to perform predictive modeling in a variety of contexts, including for example, in the field of personalized medicine. For instance, an ASK could be used to perform patient screening, disease characterization, patient stratification, and/or the like. In one such example, ASK is used to identify patients for pre-symptomatic organ failures after organ transplants via non-invasive biomarker tests. In another example, ASK is used as decision support on the efficiency of cancer combination treatment based on the patient's genotypical and phenotypical profile, drug interactions and patient-specific expected side effects. In yet another example, ASK is used to select patient groups from heart plaque cohorts that are likely to have a plaque rupture. In those example cases, the physician might access an ASK via a secure web portal access to screen patients for intervention or treatment Similarly, an ASK can be used to validate a predictive model, and/or to validate the quality of a known reference data set as a predictive modeling tool (block 875), for example by comparing models generated using the ASK with models generated from the reference data set.

In a related embodiment, the ASK can be used to model unknown data sets (block 880). Because an ASK, in one aspect, can be based upon arrays of semantic SPARQL queries, the ASK can be used to apply reasoning and inference across other, not necessarily related, unknown data sets with similar content. For example, a model for a species like mouse may also apply for the species rat without major refinements. As the SPARQL arrays contained in an ASK can be dynamically refinable and adjustable, this us of the ASK provides a convenient methodology to extend the scope of investigation and generate meaningful insights into complex inter-relationship dependent mechanisms.

In yet another embodiment, the method 800 can comprise providing decision-support for any of a number of research or clinical applications (block 885). Merely by way of example, in one embodiment, and ASK can be used to provide decision support for experimental results interpretation in translational research, drug discovery or development, and/or the like. Such decision support to include, without limitation, biomarker discovery, compound efficacy and/or toxicity screening, and/or the like. Some techniques for providing such decision-support described above.

The method 800 might also comprise providing output for a user, such as by displaying information on a screen, printing information, sending information by email, and/or the like. Often, the output will be provided via the interface, and it will depend on the nature of the application. Merely by way of example, if the ASK is used to screen an unknown data population and identify relationships therein, the output might be a display that indicates any identified relationships, as illustrated by the exemplary screen displays described above.

FIG. 9 provides a schematic illustration of one embodiment of a computer system 900 that can perform the methods provided by various other embodiments, as described herein. It should be noted that FIG. 9 is meant only to provide a generalized illustration of various components, of which one or more (or none) of each may be utilized as appropriate. FIG. 9, therefore, broadly illustrates how individual system elements may be implemented in a relatively separated or relatively more integrated manner.

The computer system 900 is shown comprising hardware elements that can be electrically coupled via a bus 905 (or may otherwise be in communication, as appropriate). The hardware elements may include one or more processors 910, including without limitation one or more general-purpose processors and/or one or more special-purpose processors (such as digital signal processing chips, graphics acceleration processors, and/or the like); one or more input devices 915, which can include without limitation a mouse, a keyboard and/or the like; and one or more output devices 920, which can include without limitation a display device, a printer and/or the like.

The computer system 900 may further include (and/or be in communication with) one or more storage devices 925, which can comprise, without limitation, local and/or network accessible storage, and/or can include, without limitation, a disk drive, a drive array, an optical storage device, solid-state storage device such as a random access memory (“RAM”) and/or a read-only memory (“ROM”), which can be programmable, flash-updateable and/or the like. Such storage devices may be configured to implement any appropriate data stores, including without limitation, various file systems, database structures, and/or the like.

The computer system 900 might also include a communications subsystem 930, which can include without limitation a modem, a network card (wireless or wired), an infra-red communication device, a wireless communication device and/or chipset (such as a Bluetooth™ device, an 902.11 device, a WiFi device, a WiMax device, a WWAN device, cellular communication facilities, etc.), and/or the like. The communications subsystem 930 may permit data to be exchanged with a network (such as the network described below, to name one example), with other computer systems, and/or with any other devices described herein. In many embodiments, the computer system 900 will further comprise a working memory 935, which can include a RAM or ROM device, as described above.

The computer system 900 also may comprise software elements, shown as being currently located within the working memory 935, including an operating system 940, device drivers, executable libraries, and/or other code, such as one or more application programs 945, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be encoded and/or stored on a computer readable storage medium, such as the storage device(s) 925 described above. In some cases, the storage medium might be incorporated within a computer system, such as the system 900. In other embodiments, the storage medium might be separate from a computer system (i.e., a removable medium, such as a compact disc, etc.), and/or provided in an installation package, such that the storage medium can be used to program, configure and/or adapt a general purpose computer with the instructions/code stored thereon. These instructions might take the form of executable code, which is executable by the computer system 900 and/or might take the form of source and/or installable code, which, upon compilation and/or installation on the computer system 900 (e.g., using any of a variety of generally available compilers, installation programs, compression/decompression utilities, etc.) then takes the form of executable code.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer system (such as the computer system 900) to perform methods in accordance with various embodiments of the invention. According to a set of embodiments, some or all of the procedures of such methods are performed by the computer system 900 in response to processor 910 executing one or more sequences of one or more instructions (which might be incorporated into the operating system 940 and/or other code, such as an application program 945) contained in the working memory 935. Such instructions may be read into the working memory 935 from another computer readable medium, such as one or more of the storage device(s) 925. Merely by way of example, execution of the sequences of instructions contained in the working memory 935 might cause the processor(s) 910 to perform one or more procedures of the methods described herein.

The terms “machine readable medium” and “computer readable medium,” as used herein, refer to any medium that participates in providing data that causes a machine to operation in a specific fashion. In an embodiment implemented using the computer system 900, various computer readable media might be involved in providing instructions/code to processor(s) 910 for execution and/or might be used to store and/or carry such instructions/code (e.g., as signals). In many implementations, a computer readable medium is a non-transitory, physical and/or tangible storage medium. Such a medium may take many forms, including but not limited to, non-volatile media, volatile media, and transmission media. Non-volatile media includes, for example, optical and/or magnetic disks, such as the storage device(s) 925. Volatile media includes, without limitation, dynamic memory, such as the working memory 935. Transmission media includes, without limitation, coaxial cables, copper wire and fiber optics, including the wires that comprise the bus 905, as well as the various components of the communication subsystem 930 (and/or the media by which the communications subsystem 930 provides communication with other devices). Hence, transmission media can also take the form of waves (including without limitation radio, acoustic and/or light waves, such as those generated during radio-wave and infra-red data communications).

Common forms of physical and/or tangible computer readable media include, for example, a floppy disk, a flexible disk, a hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read instructions and/or code.

Various forms of computer readable media may be involved in carrying one or more sequences of one or more instructions to the processor(s) 910 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 900. These signals, which might be in the form of electromagnetic signals, acoustic signals, optical signals and/or the like, are all examples of carrier waves on which instructions can be encoded, in accordance with various embodiments of the invention.

The communications subsystem 930 (and/or components thereof) generally will receive the signals, and the bus 905 then might carry the signals (and/or the data, instructions, etc. carried by the signals) to the working memory 935, from which the processor(s) 905 retrieves and executes the instructions. The instructions received by the working memory 935 may optionally be stored on a storage device 925 either before or after execution by the processor(s) 910.

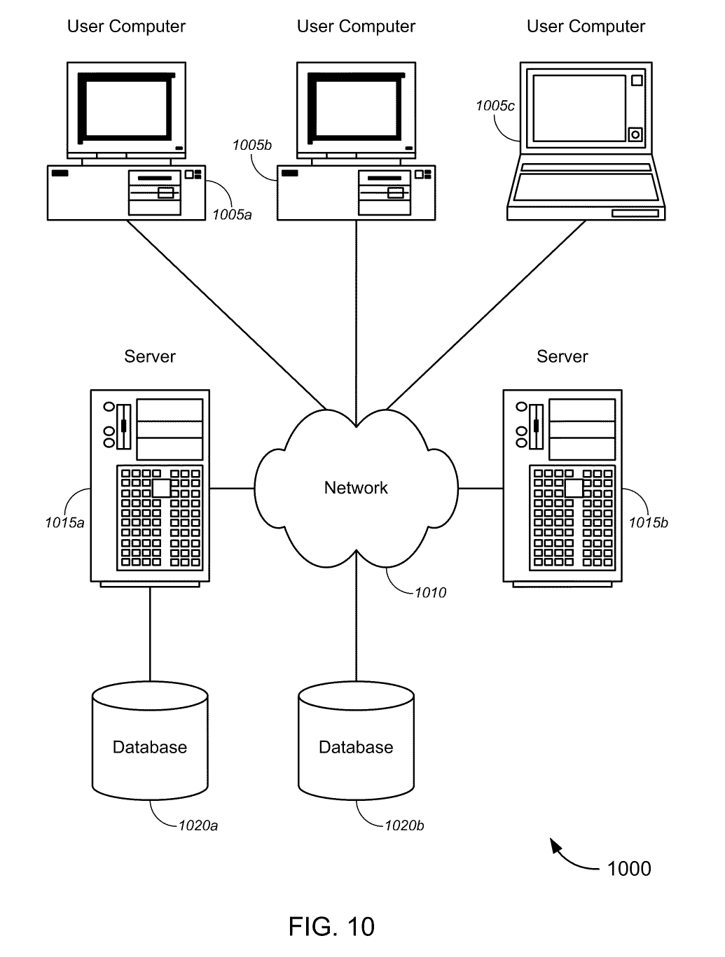

As noted above, a set of embodiments comprises systems for generating and/or implementing an ASK. Some such systems comprise multiple computers (such as one or more server computers that perform necessary processing and one or more user computers that provide an interface between a user and the server computer(s)). Merely by way of example, FIG. 10 illustrates a schematic diagram of one such system 1000 that can be used in accordance with one set of embodiments. The system 1000 can include one or more user computers 1005. A user computer 1005 can be a general purpose personal computers (including, merely by way of example, personal computers and/or laptop computers running any appropriate flavor of Microsoft Corp.'s Windows™ and/or Apple Corp.'s Macintosh™ operating systems) and/or a workstation computer running any of a variety of commercially-available UNIX™ or UNIX-like operating systems. A user computer 1005 can also have any of a variety of applications, including one or more applications configured to perform methods provided by various embodiments (as described above, for example), as well as one or more office applications, database client and/or server applications, and/or web browser applications. Alternatively, a user computer 1005 can be any other electronic device, such as a thin-client computer, Internet-enabled mobile telephone, and/or personal digital assistant, capable of communicating via a network (e.g., the network 1010 described below) and/or displaying and navigating web pages or other types of electronic documents. Although the exemplary system 1000 is shown with three user computers 1005, any number of user computers can be supported.

Certain embodiments operate in a networked environment, which can include a network 1010. The network 1010 can be any type of network familiar to those skilled in the art that can support data communications using any of a variety of commercially-available (and/or free or proprietary) protocols, including without limitation TCP/IP, SNA, IPX, AppleTalk, and the like. Merely by way of example, the network 1010 can include a local area network (“LAN”), including without limitation an Ethernet network, a Token-Ring network and/or the like; a wide-area network; a wireless wide area network (“WWAN”); a virtual network, such as a virtual private network (“VPN”); the Internet; an intranet; an extranet; a public switched telephone network (“PSTN”); an infra-red network; a wireless network, including without limitation a network operating under any of the IEEE 802.11 suite of protocols, the Bluetooth™ protocol known in the art, and/or any other wireless protocol; and/or any combination of these and/or other networks.

Embodiments can also include one or more server computers 1015. Each of the server computers 1015 may be configured with an operating system, including without limitation any of those discussed above, as well as any commercially (or freely) available server operating systems. Each of the servers 1015 may also be running one or more applications, which can be configured to provide services to one or more clients 1005 and/or other servers 1015.

Merely by way of example, one of the servers 1015 may be a web server, which can be used, merely by way of example, to process requests for web pages or other electronic documents from user computers 1005. The web server can also run a variety of server applications, including HTTP servers, FTP servers, CGI servers, database servers, Java servers, and the like. In some embodiments of the invention, the web server may be configured to serve web pages that can be operated within a web browser on one or more of the user computers 1005 to perform methods of the invention.

The server computers 1015, in some embodiments, might include one or more application servers, which can be configured with one or more applications accessible by a client running on one or more of the client computers 1005 and/or other servers 1015. Merely by way of example, the server(s) 1015 can be one or more general purpose computers capable of executing programs or scripts in response to the user computers 1005 and/or other servers 1015, including without limitation web applications (which might, in some cases, be configured to perform methods provided by various embodiments). Merely by way of example, a web application can be implemented as one or more scripts or programs written in any suitable programming language, such as Java™, C, C#™ or C++, and/or any scripting language, such as Perl, Python, or TCL, as well as combinations of any programming and/or scripting languages. The application server(s) can also include database servers, including without limitation those commercially available from Oracle, Microsoft, Sybase™, IBM™ and the like, which can process requests from clients (including, depending on the configuration, dedicated database clients, API clients, web browsers, etc.) running on a user computer 1005 and/or another server 1015. In some embodiments, an application server can create web pages dynamically for displaying the information in accordance with various embodiments, such as the web pages displayed in the exemplary screens described above. Data provided by an application server may be formatted as one or more web pages (comprising HTML, JavaScript, etc., for example) and/or may be forwarded to a user computer 1005 via a web server (as described above, for example). Similarly, a web server might receive web page requests and/or input data from a user computer 1005 and/or forward the web page requests and/or input data to an application server. In some cases a web server may be integrated with an application server.

In accordance with further embodiments, one or more servers 1015 can function as a file server and/or can include one or more of the files (e.g., application code, data files, etc.) necessary to implement various disclosed methods, incorporated by an application running on a user computer 1005 and/or another server 1015. Alternatively, as those skilled in the art will appreciate, a file server can include all necessary files, allowing such an application to be invoked remotely by a user computer 1005 and/or server 1015.

It should be noted that the functions described with respect to various servers herein (e.g., application server, database server, web server, file server, etc.) can be performed by a single server and/or a plurality of specialized servers, depending on implementation-specific needs and parameters.

In certain embodiments, the system can include one or more databases 1020. The location of the database(s) 1020 is discretionary: merely by way of example, a database 1020a might reside on a storage medium local to (and/or resident in) a server 1015a (and/or a user computer 1005). Alternatively, a database 1020b can be remote from any or all of the computers 1005, 1015, so long as it can be in communication (e.g., via the network 1010) with one or more of these. In a particular set of embodiments, a database 1020 can reside in a storage-area network (“SAN”) familiar to those skilled in the art. (Likewise, any necessary files for performing the functions attributed to the computers 1005, 1015 can be stored locally on the respective computer and/or remotely, as appropriate.) In one set of embodiments, the database 1035 can be a relational database, such as an Oracle database, that is adapted to store, update, and retrieve data in response to SQL-formatted commands. The database might be controlled and/or maintained by a database server, as described above, for example.

Various tools and techniques described herein for generating ASKs and/or for implementing them for predictive modeling and screening constitutes a new approach to facilitate reliable decisions in complex and difficult to understand systems-process related data aggregates. Using practical institutional and acquired knowledge to reveal previously hidden relationships and conditions which impact a biological phenomenon, certain embodiments provide toolsets necessary to make informed decisions with confidence in mission-critical challenges, such as, for example, early identification of drug efficacy; presymptomatic toxicity detection; unwanted drug interactions in multi-drug therapy; detection of presymptomatic organ failure; and, identification and stratification of cases by disease type for targeted trials or treatment.

While certain features and aspects have been described with respect to exemplary embodiments, one skilled in the art will recognize that numerous modifications are possible. For example, the methods and processes described herein may be implemented using hardware components, software components, and/or any combination thereof. Further, while various methods and processes described herein may be described with respect to particular structural and/or functional components for ease of description, methods provided by various embodiments are not limited to any particular structural and/or functional architecture but instead can be implemented on any suitable hardware, firmware and/or software configuration. Similarly, while various functions are ascribed to certain system components, unless the context dictates otherwise, this functionality can be distributed among various other system components in accordance with the several embodiments.

Moreover, while the procedures of the methods and processes described herein are described in a particular order for ease of description, unless the context dictates otherwise, various procedures may be reordered, added, and/or omitted in accordance with various embodiments. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with—or without—certain features for ease of description and to illustrate exemplary aspects of those embodiments, the various components and/or features described herein with respect to a particular embodiment can be substituted, added and/or subtracted from among other described embodiments, unless the context dictates otherwise. Consequently, although several exemplary embodiments are described above, it will be appreciated that the invention is intended to cover all modifications and equivalents within the scope of the following claims.

What is claimed is:

1. A method, comprising:
importing, into an informatics program, a plurality of sets of data from a plurality of sources;
synthesizing the plurality of sets of data to produce a coherent data set;
creating one or more semantic networks, the semantic networks expressing data relationships among data in the coherent data set;
obtaining a pattern characteristic for a biologically relevant function by reducing network complexity of the one or more semantic networks;
generating one or more SPARQL arrays from the pattern characteristic;
storing the one or more SPARQL arrays in a database; and
generating an applied semantic knowledgebase from the one or more SPARQL arrays.

2. The method of claim 1, further comprising:
screening an unknown data population with one or more of the SPARQL arrays;
identifying one or more relationships in the unknown data population, based on the screening; and
displaying an indication of the one or more relationships in a user interface.

3. An apparatus, comprising:
a computer readable medium having encoded thereon a set of instructions executable by one or more computers to perform one or more operations, the set of instructions comprising:
instructions for importing, into an informatics program a plurality of sets of data from a plurality of sources;
instructions for synthesizing the plurality of sets of data to produce a coherent data set;
instructions for creating one or more semantic networks, the semantic networks expressing data relationships among data in the coherent data set;
instructions for obtaining a pattern characteristic for a biologically relevant function by reducing network complexity of the one or more semantic networks;
instructions for generating one or more SPARQL arrays from the pattern characteristic;
instructions for storing the one or more SPARQL arrays in a database; and
instructions for generating an applied semantic knowledgebase from the one or more SPARQL arrays.

4. A computer system, comprising:
one or more processors; and
a computer readable medium in communication with the one or more processors, the computer readable medium having encoded thereon a set of instructions executable by the computer system to perform one or more operations, the set on instructions comprising:
instructions for importing, into an informatics program a plurality of sets of data from a plurality of sources;
instructions for synthesizing the plurality of sets of data to produce a coherent data set;
instructions for creating one or more semantic networks, the semantic networks expressing data relationships among data in the coherent data set;
instructions for obtaining a pattern characteristic for a biologically relevant function by reducing network complexity of the one or more semantic networks;
instructions for generating one or more SPARQL arrays from the pattern characteristic;
instructions for storing the one or more SPARQL arrays in a database; and
instructions for generating an applied semantic knowledgebase from the one or more SPARQL arrays.

5. A method, comprising,
generating an applied semantic knowledgebase from one or more SPARQL arrays;
screening an unknown data population with one or more of the SPARQL arrays;
identifying one or more relationships in the unknown data population, based on the screening; and
displaying an indication of the one or more relationships in a user interface.

6. The method of claim 5, wherein generating an applied semantic knowledgebase comprises merging a plurality of data sets under a common ontology to produce a unified semantic network.

7. The method of claim 6, wherein the unified semantic network is multidimensional.

8. The method of claim 6, wherein generating an applied semantic knowledgebase further comprises:
displaying a plurality of markers from within the semantic network;
receiving a selection of a set of markers from within the plurality of markers, the selected set of markers representing a sub-network of the semantic network; and
saving the sub-network as a SPARQL array.

9. The method of claim 5, wherein generating an applied semantic knowledgebase comprises generating an applied semantic knowledgebase based on patterns or profiles representing characteristics in datasets applicable to predictive modeling and screening.

10. The method of claim 9, wherein generating an applied semantic knowledgebase further comprises:
performing one or more SPARQL queries to identify said patterns or profiles; and
saving said patterns or profiles as one or more applied semantic knowledgebases.

11. The method of claim 10, wherein the one or more SPARQL queries comprises a textual query.

12. The method of claim 10, wherein the one or more SPARQL queries comprises a graphical query.

13. The method of claim 10, wherein the one or more SPARQL queries comprises a numeric query.

14. The method of claim 5, further comprising:
validating, with the applied semantic knowledgebase, a predictive modeling quality of one or more known reference datasets.

15. The method of claim 5, further comprising:
modeling, with the applied semantic knowledgebase, one or more unknown datasets.

16. The method of claim 5, further comprising:
providing decision support, with the applied semantic knowledgebase, for experimental result interpretation in translational research.

17. The method of claim 5, further comprising:
providing decision support, with the applied semantic knowledgebase, for experimental result interpretation in drug discovery or development.

18. The method of claim 17, wherein providing decision support comprises target validation.

19. The method of claim 17, wherein providing decision support comprises biomarker discovery.

20. The method of claim 17, wherein biomarker discovery comprises compound efficacy and toxicity screening.

21. The method of claim 5, further comprising:
performing predictive modeling, using the applied semantic knowledgebase, in a personalized medicine application.

22. The method of claim 21, wherein the personalized medicine application is selected from the group consisting of patient screening, disease characterization and patient stratification.

23. An apparatus, comprising:
a computer readable medium having encoded thereon a set of instructions executable by one or more computers to perform one or more operations, the set of instructions comprising:
instructions for generating an applied semantic knowledgebase from one or more SPARQL arrays;
instructions for identifying one or more relationships in the unknown data population, based on the screening; and
instructions for displaying an indication of the one or more relationships in a user interface.

24. A computer system, comprising:
one or more processors; and
a computer readable medium in communication with the one or more processors, the computer readable medium having encoded thereon a set of instructions executable by the computer system to perform one or more operations, the set on instructions comprising:
instructions for generating an applied semantic knowledgebase from one or more SPARQL arrays;
instructions for identifying one or more relationships in the unknown data population, based on the screening; and
instructions for displaying an indication of the one or more relationships in a user interface.
